(19) United States
(12) Patent Application Publication
(10) Pub. No.: US 2026/0141190 A1
(43) Pub. Date: May 21, 2026

(54) HIGHER-ORDER FUNCTION WITH REDUCING FUNCTION PARAMETER TO TRANSLITERATE CHARACTERS

(71) Applicant: MASTERCARD INTERNATIONAL INCORPORATED, Purchase, NY (US)

(72) Inventors: Kristóf GYIMESI, Budapest (EU); Péter ANDI, Budapest (EU); Amit ANAND, Kirkland, WA (US)

(73) Assignee: MASTERCARD INTERNATIONAL INCORPORATED, Purchase, NY (US)

(21) Appl. No.: 18/952,946

(22) Filed: Nov. 19, 2024

(51) Int. Cl. G06F 40/47; G06F 40/53

(52) U.S. Cl. CPC G06F 40/47; G06F 40/53

(57) ABSTRACT

Systems and methods of computational transliteration of an input sequence of characters in a source language such as Thai to a target language such as Latin. The output may include Romanization of Thai names. The output sequence may be used for machine transliteration understanding of words such as proper nouns. A system may execute a higher-order function that calls a reducing function that iterates through sliding windows of an input sequence and updates, with each iteration, an accumulator map that includes a vector of characters and an indication of a number of characters that can be skipped when processing the next window. Each window includes multiple characters in the input sequence for context-based transliteration using contextual transcription rules. Characters can be skipped when they have already been processed in a previous sliding window. Transliteration of certain source languages may include transposition, deletion, insertion, and transcription.

### BACKGROUND

Generally, machine transliteration is a computational process in which a computer converts characters in a first writing system to a second writing system. More specifically, machine transliteration involves converting characters in a source (natural or spoken) language to a target (natural or spoken) language. Machine transliteration can be useful in various contexts including cross-language search engines, machine translation systems, and geographic information systems, among others. The highly variable nature of languages used throughout the world can make machine transliteration inaccurate and prone to errors.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment of automatically transliterating text in a first language to a second language;

FIG. 2 illustrates a schematic example of transliteration operations that include transposition, deletion, insertion and transcription;

FIG. 3 illustrates examples of preposed vowels for transposition;

FIG. 4 illustrates examples of transpositions for transliteration;

FIG. 5 illustrates examples of deletions subject to deletion rules;

FIG. 6 illustrates examples of insertions subject to insertion rules;

FIG. 7 illustrates examples of transcription based on conversion tables;

FIG. 8 illustrates an example of a method for context-based transliteration of a source language into a target language based on a higher-order function and a reducing function;

FIG. 9A illustrates an example of a conversion table for consonants;

FIG. 9B illustrates an example of a conversion table for vowels; and

FIG. 10 illustrates an example of a computer system that may be implemented by devices illustrated in FIG. 1.

### DETAILED DESCRIPTION

The disclosure relates to machine transliteration of characters from a source language such as Thai to a target language such as Latin based on a higher-order function that executes a reducing function. A higher-order function is a function that takes, as input, the reducing function and one or more parameters for the reducing function. The reducing function performs context-dependent transliteration of characters in an input sequence based on a sliding window. Each sliding window includes of number of characters in the input sequence defined by a parameter input provided by the higher-order function. The reducing function iteratively moves the sliding window across the input sequence. At each iteration, the reducing function transliterates a character based on other characters in a corresponding sliding window for context, accumulates the result of each iteration, and returns an accumulation map of the results. The accumulation map includes, among other things, a vector of characters that is fed back to the reducing function for the next iteration, during which the reducing function repeats transliteration for the next sliding window. After the last sliding window is iterated, the higher-order function generates a transliterated sequence of characters based on the vector of characters. The higher-order function and reducing function architecture enables iterative traversal of the input sequence to transliterate each character in the input sequence with adjacent characters in scope for more accurate results. The architecture further enables scalable transliteration due to the extensible vector of characters.

The higher-order function takes as input parameters including: (1) an input sequence of characters to be transliterated, (2) a size of a sliding window to use (the number of characters that from the input sequence that is included in a sliding window), and (3) a reducing function that iterates each sliding window that is generated from the input sequence and transliterates characters in the sliding window. The higher-order function parameterizes the input sequence and the size of the sliding window for input to the reducing function. The reducing function implements sliding windows for iteratively traversing the input sequence and includes logic for transliteration at each iteration.

The transliteration logic includes transposition, deletion, insertion, and transcription operations. In some instances, the transliteration logic executes transposition, deletion, insertion, and transcription in sequence (one after the other in order starting with transposition). These transliteration operations may be based on one or more conversion tables and one or more contextual rules. Some or all of these tables and contextual rules are specific to the source and/or target language. Thus, the transliteration logic may be customized based on configuration of the tables and/or rules to handle transliteration for specific languages.

Transposition is a shift in an order of characters in an input sequence. The result of transposition is that one or more characters are moved earlier or later in the input sequence. Transposition is applied to address shifts in pronounced characters. For example, in some languages, certain characters such as vowels are pronounced earlier or later than where they are written. To illustrate, some vowel sounds may be written earlier in a word but are pronounced as if they are written later in the word. As such, the transliteration logic may include transposition to handle languages that have these and other shifts. Transposition may be subject to a stopping condition that terminates further transpositions based on context. For example, a stopping condition may include a maximum number of transpositions (such as a maximum of two transpositions before stopping further transpositions) and/or if the next character is a tone mark or a vowel character.

Deletion is the removal of one or more characters from the input sequence. In some languages, certain characters are written but not pronounced. One or more deletion rules may specify when this occurs and how to handle them. In some instances, certain characters are unneeded for transliteration. For example, special marks such as tone marks are unneeded for transliteration and may are deleted. Insertion is the addition of one or more characters to the input sequence. In some languages, certain sounds are pronounced but not written. In this case, the transliteration logic may include insertion to address these instances.

Transcription is the process of converting a character in the source language into a character in the target language. Transcription can be a complex task that is context-dependent. For example, in some languages, there may exist character combinations that need to be transliterated together. Because of this, transliteration may include transcription that takes into account the context of each character to recognize character combinations that must be transliterated together.

The reducing function may include logic for transliteration (such as transposition, deletion, insertion, and transcription) that needs to be checked for a sliding window. Additionally, the result is updated in the f function if a contextual rule 143 applies. Due to the application of some rules that were applied to a cluster of letters in a sliding window, some sliding windows may be skipped because those characters were already processed in a previous rule application and the result was already updated. As such, the accumulator map 171 includes a skip integer 175 value that indicates a skip-next-N entry (in which n is an integer). Because this map is the return value of the reduce function, it will be passed along for the next iteration. If the value of the key skip-next-n is greater than zero, then the same result is returned in the accumulator function with a decremented value of skip-next-n. This way, the next sliding, which would contain an already processed letter, is skipped.

In some examples, because of the application of rules for transliteration that were applied to a cluster of letters in a sliding window, some sliding windows may be skipped because those characters were already processed in a previous iteration and the result was already updated. As such, the accumulator map includes a skip integer value that indicates a skip-next-N entry (in which n is an integer). Because this map is the return value of the reduce function, it will be passed along for the next iteration. If the value of the key skip-next-n is greater than zero, then the same result is returned in the accumulator function with a decremented value of skip-next-n. In this manner, the next sliding window, which contains an already processed character, may be skipped.

The higher-order function and reducing function architecture improves transliteration and machine transliteration systems by facilitating context-depending transliteration of the characters in an efficient manner. Furthermore, transliteration may scale to specifically account for issues that can arise when transliterating certain source languages. For example, the reducing function may use conversion tables and contextual rules that are specifically configured for source and/or target languages. By generating and updating a vector of characters in the accumulation map, transliteration may scale to larger input sequences. Having described a high level overview of some system functions, attention will now turn to a system environment in which these functions operate.

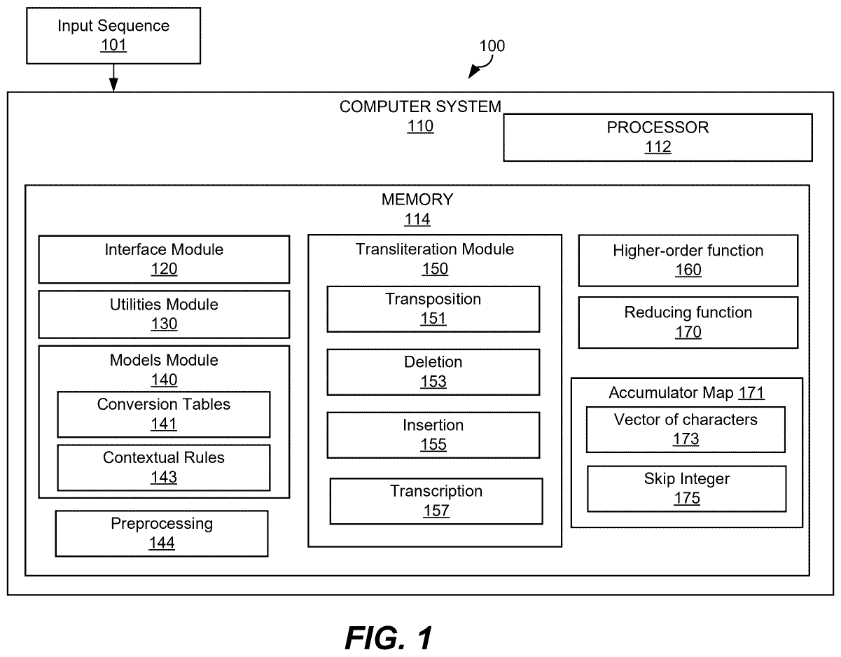

FIG. 1 illustrates an example of a system environment 100 of automatically transliterating text in a source language to a second language target language. In particular, the computer system 110 may take as input a sequence of characters in the source language and transliterate them into a sequence of characters in the target language.

The system environment 100 may include a computer system 110. The computer system 110 may include a processor 112, a memory 114, and/or other features. The memory 114 may store instructions that programs the processor 112. The instructions may include an interface module 120, a utilities module 130, a models module 140, a transliteration module 150, and/or other features.

The interface module 120 contains the functions that the user can call to transliterate a Thai name into Latin. The transliteration function defined here has a prerequisite, that the string must be cleaned before passing the name to the function. This function composes together the transliteration with the splitting of the input string, and then concatenating of the result.

The utilities module 130 contains helper functions, that are not specific to any steps of the transliteration process and are used at multiple locations at the code. For example, the utilities module 130 may include a rolling window function that defines a window having a window size of N characters from the input sequence 101 for analysis (in which N is an integer), then shifts the window to the next window for analysis of the next N characters. Any two adjacent windows may or may not overlap, depending on particular needs.

The models module 140 may include conversion tables 141, contextual rules 143, and/or other features. The models module 140 contains the constant data models for transliterating, such as the conversion tables, regular expression patterns and letter dependencies for contextual rules. A conversion table 141 is a data structure that stores an association between one or more characters in a source language and a corresponding one or more characters in a target language. The conversion table 141 may therefore be used as a lookup structure to convert a character in the source language to a character in the target language. These conversions may be context-specific. For example, some source languages may include context that dictates when conversion should or should not apply. Thus, a character of the source language in an input sequence is not necessarily always replaced with a corresponding character in the target language, but rather may be subject to contextual rules 143. The conversion tables 141 and contextual rules 143 are specific to the particular source and target languages. Thus, the conversion tables 141 and/or contextual rules 143 may be customized for different pairs of source and target languages.

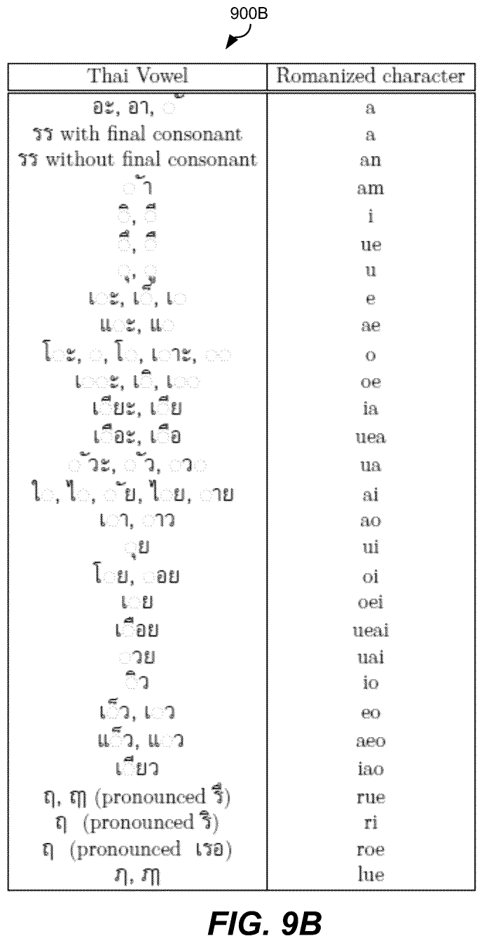

In the examples described herein throughout, the source language will be the Thai language and the target language will be Latin. In these examples, the transliteration process will be referred to as Romanization of Thai. The conversion tables 141 and/or contextual rules 143 in these examples are based on a refactored version of the ISO 11940-2 Standard, which is incorporated by reference in its entirety herein for all purposes. However, it should be understood that other source languages may be transliterated to Latin and/or other target languages based on similar linguistic characteristics and the disclosures herein. Similarly, the Thai language may be transliterated to other target languages. In these other examples, the conversion tables 141 and contextual rules 143 will be configured for the specific source and target languages, similar to the manner disclosed herein, but customized for those languages. Examples of conversion tables 900A and 900B for consonants and vowels are respectively illustrated in FIGS. 9A and 9B.

### Preprocessing

In some examples, the computer system 110 may perform preprocessing 144 to preprocess the input sequence 101 prior to transliteration by the transliteration module 150. Preprocessing 144 may perform string cleaning, which is a process of removing undesirable characters, symbols, and formatting from a given string of text. The cleaning of the input sequence 101 and in particular proper nouns such as names in the sequence may be beneficial to mitigate errors, such as human errors, or other junk characters that are in the input sequence 101 and are not meaningful to transliterate. Characters that should otherwise be removed may cause transliteration errors. This is because contextual rules used in transliteration analyze a given character in the context of surrounding positions in the input sequence 101 relative to one other. Thus, junk characters that remain may provide false context, as well as unnecessary computer processing power. For example, when working with names, cleaning before any transliteration can mitigate unexpected results from transliteration of otherwise junk characters. Preprocessing 144 may include lowercasing, substituting separate characters with space, removing certain characters such as punctuation, currency symbols, mathematical symbols, or other non-letter symbols, replacing whitespace characters with a single space, and/or other cleaning operations to remove unwanted characters.

After this preprocessing 144, if any character remains in the input sequence 101, then Idit should be a letter of a language available in the Unicode charts or a space. Thus, any non-source characters (such as Thai characters) that remain in the input sequence 101 should be retained. For example, a first name in the input sequence 101 may include Latin characters, but a last name may include Thai characters. In this case, the Latin characters should be retained and the Thai characters will be transliterated. Thus, preprocessing 144 may recognize the occurrence of multiple languages and keeping separate these languages will aid downstream transliteration. It should be noted that multiple languages may be included in the input sequence 101, in which case all of these should be retained for further processing.

### Transliteration

The transliteration module 150 may transliterate the input sequence 101 (which may have been preprocessed) based on one or more computational operations. For example, the computational operations may include transposition 151, deletion 153, insertion 155, and transcription 157.

Transliteration expects a string, in which the words are separated with spaces and all the unwanted characters are removed. This is guaranteed by the string cleaning process, which takes place before the transliteration begins. In the beginning, the strings are split up by the spaces, then each part is transliterated to Latin script. After this, it returns the parts in one string concatenated by spaces.

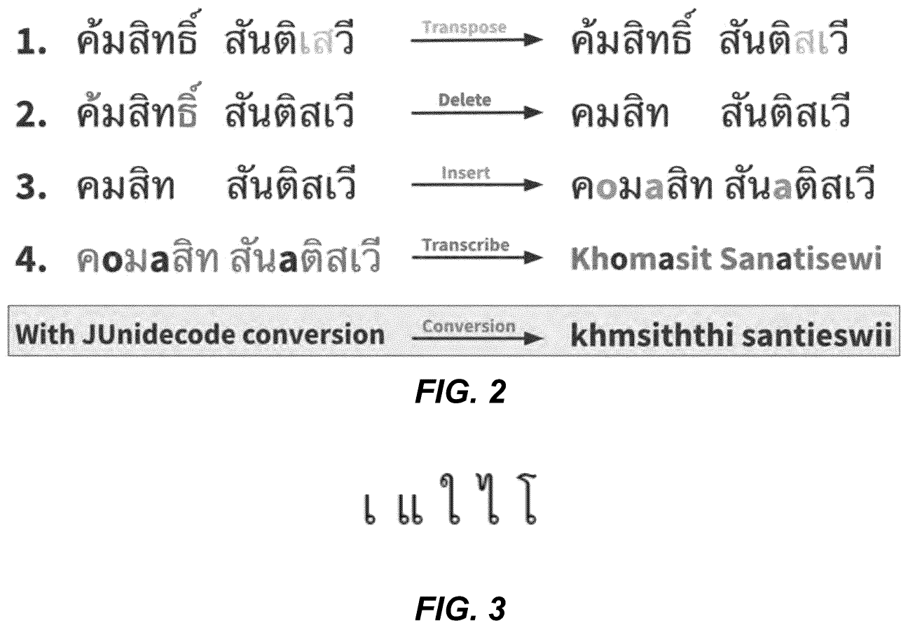

FIG. 2 illustrates a schematic example of transliteration operations that include transposition 151, deletion 153, insertion 155 and transcription 157. The schematic example 200 illustrates transliteration of Thai characters into Latin, though other source languages may be transliterated into other target languages. In some examples, transposition 151, deletion 153, insertion 155 and transcription 157 are performed sequentially, one after the other, starting with transposition 151 through transcription 157. FIG. 2 illustrates the transliteration process for the Thai name [symbol] (Khomasit Sanatisewi). FIG. 2 also illustrates romanization for the same name with JUnidecode conversion, illustrating the difference between the two results.

### Transposition

In some languages, certain characters such as vowels are pronounced earlier or later than where they are written. For example, in the Thai language, some vowels may appear earlier in a word but are pronounced as if they are written later in the word. As such, during transliteration, these character transpositions may be taken into account. In the previous example, romanization of the Thai language will take into account the vowel's transposed vocalization. When a letter is transposed, it is moved in front of the character on its right.

Transposition 151 may be based on one or more transposition rules that are specific to the source language and define when and how to transpose characters. This shifting in character order can happen once or twice, based on the vowel's adjacent character on the right. In some examples, transposition 151 may be subject to a stopping condition that terminates further transpositions. For example, a stopping condition may include a maximum number of transpositions (such as a maximum of two transpositions before stopping further transpositions) and/or if the next character is a tone mark or a vowel character.

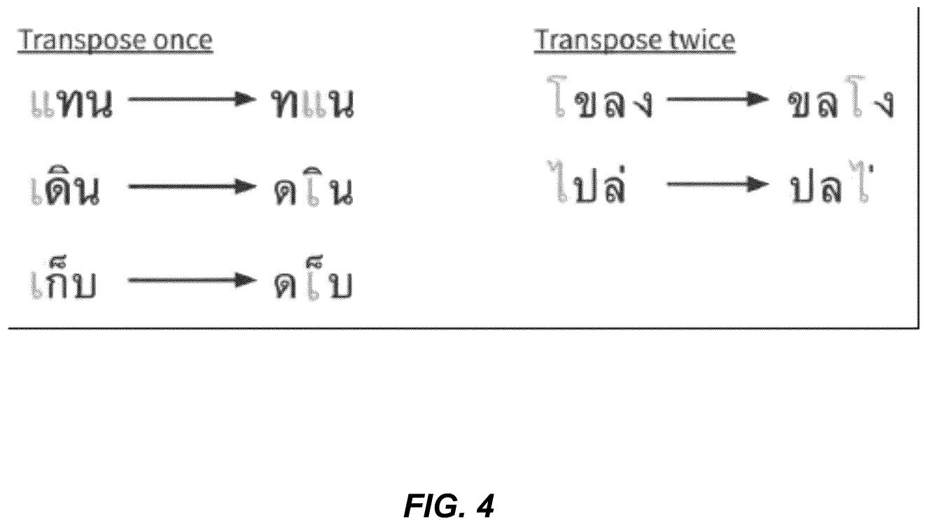

In the case of the Thai alphabet, there are five vowels that can be transposed. They are called preposed vowels. For example, FIG. 3 illustrates examples of preposed vowels for transposition.

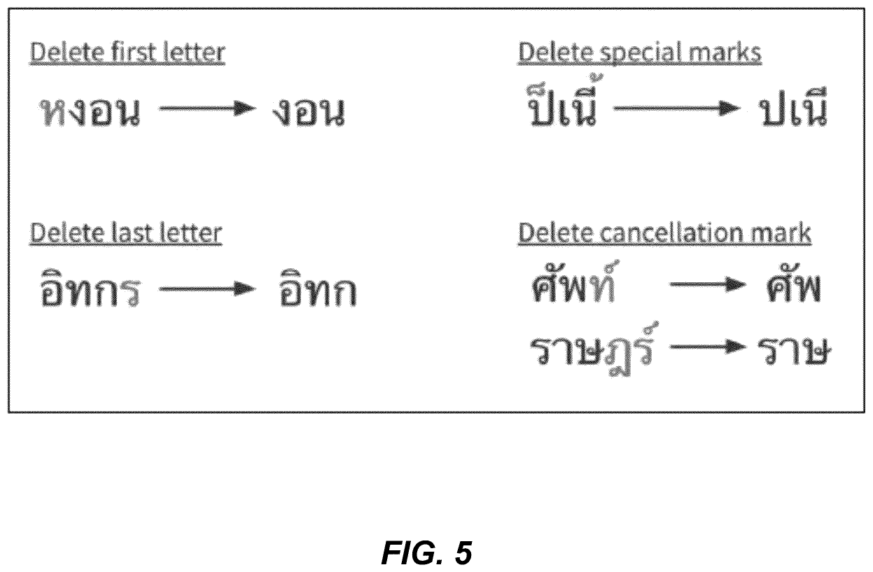

A transposition rule may specify that preposed letters are to be transposed only if they are next to certain consonant characters. Transposition may stop if the next character is a vowel, tone mark or special mark, or other stopping condition is triggered. FIG. 4 illustrates examples of transpositions for transliteration.

### Deletion

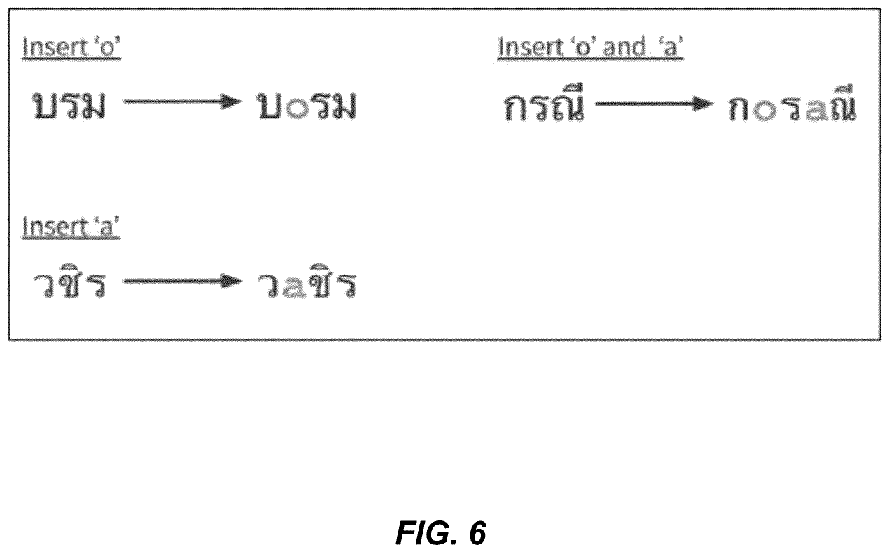

In some languages, certain characters are written but not pronounced. For example, in the Thai language, this can happen with the first or last letter of the word based on the consonant in position. One or more deletion rules may specify when this occurs and how to handle them. In some instances, certain characters are unneeded for transliteration. For example, special marks such as tone marks in the Thai language, are not needed for romanization. In these instances, the deletion rules may specify that these or other characters are to be deleted. FIG. 5 illustrates examples of deletions subject to deletion rules. Deletion 153 may delete certain characters subject to the deletion rules.

### Insertion

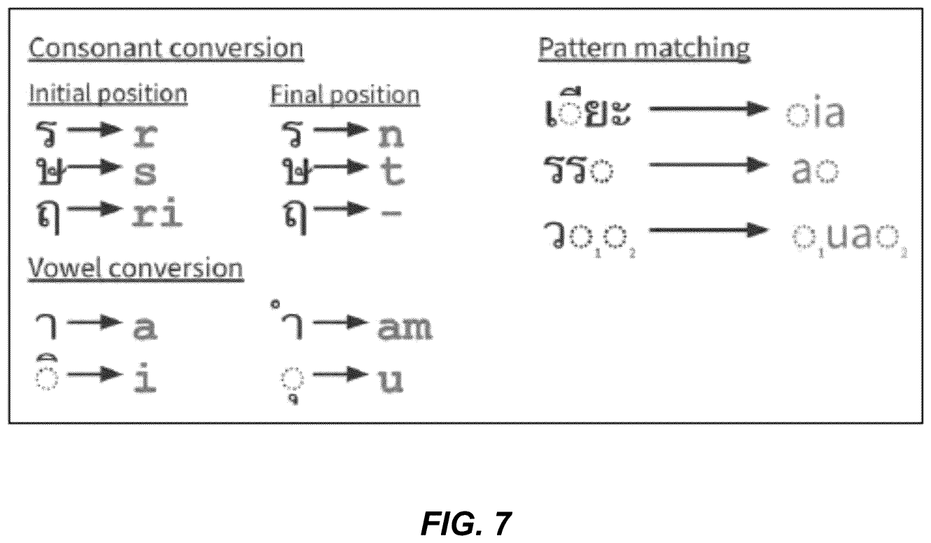

In some languages, certain sounds are pronounced but not written. For example, in the spoken language of Thai, sometimes short ‘a’s or ‘o’s are pronounced in words, even though they are not written. This insertion is based on ambiguous contextual rules. For example, the ISO 11940-2 Standard includes rules about these insertions, but they are vague and contradictory. Thus, they insertion 155 may use refactored insertion rules to insert ‘a’s and ‘o’s more accurately in the Thai language. Other insertion rules may be used for other languages. FIG. 6 illustrates examples of insertions subject to insertion rules.

### Transcription

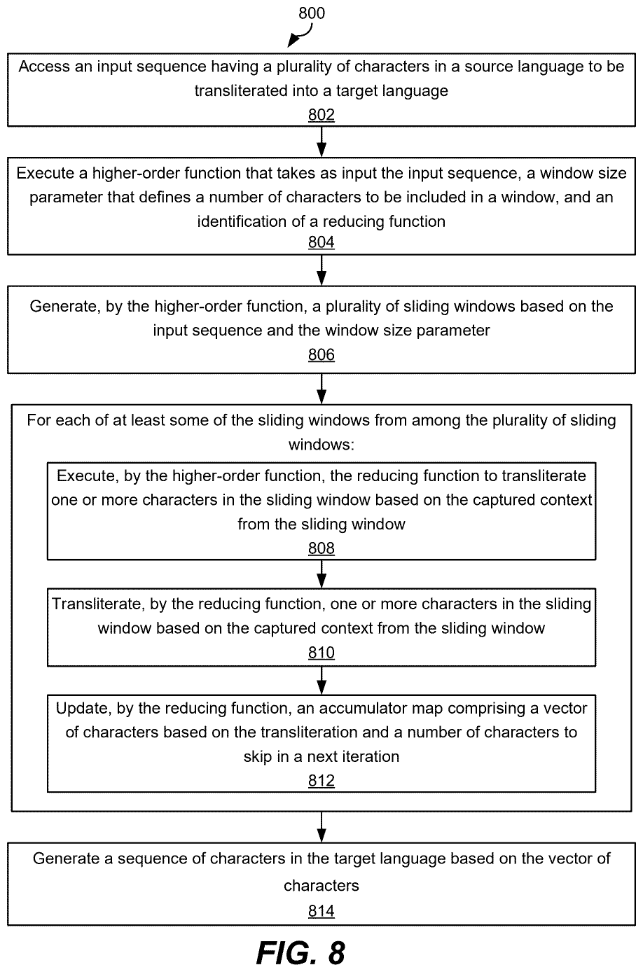

Upon transposition, deletion and insertion, transcription 157 converts the characters in the input sequence 101 from the source language into the target language based on the conversion tables 141. Transcription 157 may be a complex task because there may exist character such as letter combinations that need to be transliterated together. Because of this, transcription 157 takes into account the context of each character to recognize character combinations that must be transliterated together. For the Thai language, the ISO 11940-2 standard may be used as the basis for conversion tables 141 for vowels and consonants, but are modified to better-fit data and improve performance. FIG. 7 illustrates examples of transcription based on conversion tables 141.

### Execution of the Transliteration Module 150

The transliteration module 150 may be implemented using a higher-order function 160 that takes as input and executes a reducing function 170. In this case, the higher-order function 160 takes as input the reducing function 170. The higher-order function 160 and reducing function 170 architecture permits iteration through the input sequence 101 using sliding windows that keeps adjacent characters in scope when transliterating a character in the input sequence 101, as shown below. An example of this implementation is illustrated in Table 1.

Table 1. In the example shown in Table 1, the higher-order function 160 is implemented as the “process-seq-over-n-window routine” in which the input sequence 101 is provided as the “seq” parameter, the window size is provided as the “number-of-elements-to-peek” and the input reducing function 170 is provided as the “f” reduce function.

```
(defn process-seq-over-n-window
  [seq number-of-elements-to-peek f]
  (−> (reduce
    (fn [{:keys [result skip-next-n]
      :as acc} partitioned-characters]
        (if (< 0 skip-next-n)
          {:result result
            :skip-next-n (dec skip-next-n)}
            (f acc partitioned-characters)))
    {:result [ ]
      :skip-next-n 0}
      (partition-all number-of-elements-to-peek 1 seq))
    :result))
```

The process-seq-over-n-window takes three parameters: (1) “seq” (an input sequence of characters), (2) “number-of-elements-to-peek” (a number of characters that should fit in one sliding window), and (3) “f” (a reducing function that is applied to each sliding window that is generated from the input sequence). At the end of the iteration, the function returns a transliterated sequence of characters.

As illustrated, the process-seq-over-n-window uses the higher-order function called thread first macro, which is represented with the arrow symbol (->). This function is a macro and it is useful to make the code more readable, because it can remove nesting from function calls or retrieve data from deeply nested data structures. The thread first macro takes its first parameter, and pipes it through as the first parameter of the first passed function. After this the thread first macro gets the result of that function, and passes that result to the next function as the first parameter. It repeats this process until there is no other parameter left. In this case, the thread first macro takes the value corresponding to the: result key in the generated structure by the first element.

The traversing of the input sequence of characters is performed by the function called reduce, which is a higher-order function that reduces a sequence of values to a single value based on a reducing function and an accumulator object. As the reduce function traverses the input string, the result of the computation is stored in the accumulator object. This parameter is passed on to the next iteration. Thus, the passed parameter represents the current state of the reduction process. In this example, the object is a map that contains the result vector of characters 173 and a skip integer 175 that indicates whether the reducing function should skip a number of characters.

For the input value of the reduce function, the partition-all function is used to create the sliding window on the given input sequence. Thus, the reduce function is able to process a given character in the context of adjacent characters (such as a number of characters after the character). In this architecture, a data structure can be easily traversed with the reduce function because the partition-all function creates a sequence of partitions from a given input sequence. It is passed length of the partitions, the step between partitions, and a sequence to be processed. In this example, the step is one to create partitions for the entire input sequence without skipping any possible any sliding windows.

Due to the structure of the process-seq-over-n-window function, the passed f reducing function may include a specific structure as illustrated in Table 2:

(defn f
[{:keys [result skip-next-n]} [first second third ...]]

The first parameter is a map, which contains keys for the reduce function's accumulator map. The second parameter of the f function is a vector of characters, that should have a length of the number-of-elements-to-peek parameter of the process-seq-over-n-window function. This is needed, because this sequence will represent one partition that reduce passes to it. In the f function's structure this sequence is destructed to characters like first, second, third and so on, to be easily accessible while processing.

The f function may include logic for transliteration (such as transposition, deletion, insertion, and transcription) that needs to be checked for a sliding window. Additionally, the result is updated in the f function if a contextual rule 143 applies. Due to the application of some rules that were applied to a cluster of letters in a sliding window, some sliding windows may be skipped because those characters were already processed in a previous rule application and the result was already updated. As such, the accumulator map 171 includes a skip integer 175 value that indicates a skip-next-N entry (in which n is an integer). Because this map is the return value of the reduce function, it will be passed along for the next iteration. If the value of the key skip-next-n is greater than zero, then the same result is returned in the accumulator function with a decremented value of skip-next-n. In this manner, the next sliding window, which would contain an already processed letter, may be skipped.

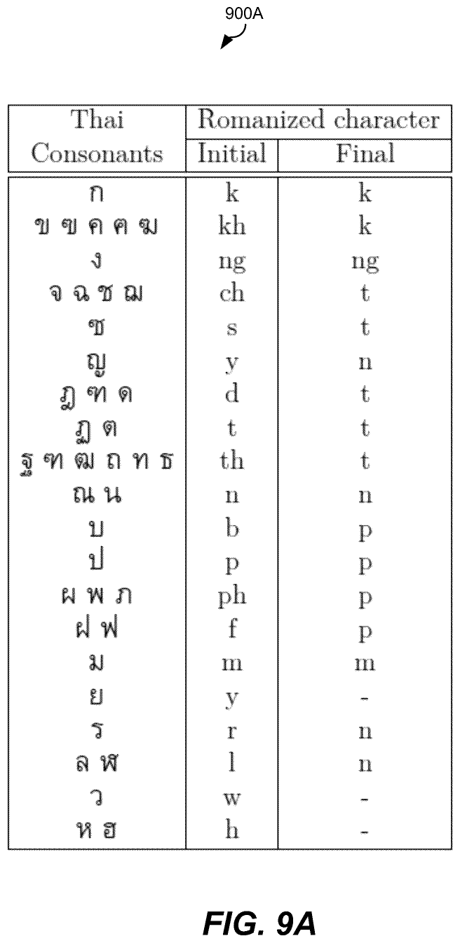

FIG. 8 illustrates an example of a method for context-based transliteration of a source language into a target language based on a higher-order function 160 and a reducing function 170;

At 802, the method 800 may include accessing an input sequence 101 having a plurality of characters in a source language to be transliterated into a target language. At 804, the method 800 may include executing a higher-order function (such as the higher-order function 160) that takes as input the input sequence, a window size parameter that defines a number of characters to be included in a window, and an identification of a reducing function 170 (such as the reducing function 170).

At 806, the method 800 may include generating, by the higher-order function, a plurality of sliding windows based on the input sequence and the window size parameter, wherein each sliding window comprises a number of characters from the input sequence that is based on the window size to capture context for one or more characters in the sliding window to be transliterated.

For each of at least some of the sliding windows from among the plurality of sliding windows, the method 800 may include 808, 810, and 812. At 808, the method 800 may include executing, by the higher-order function, the reducing function to transliterate one or more characters in the sliding window based on the captured context from the sliding window. At 810, the method 800 may include transliterating, by the reducing function, one or more characters in the sliding window based on the captured context from the sliding window. At 812, the method 800 may include updating, by the reducing function, an accumulator map 171 comprising a vector of characters based on the transliteration and a number of characters to skip in a next iteration.

At 814, the method 800 may include generating a sequence of characters in the target language based on the vector of characters.

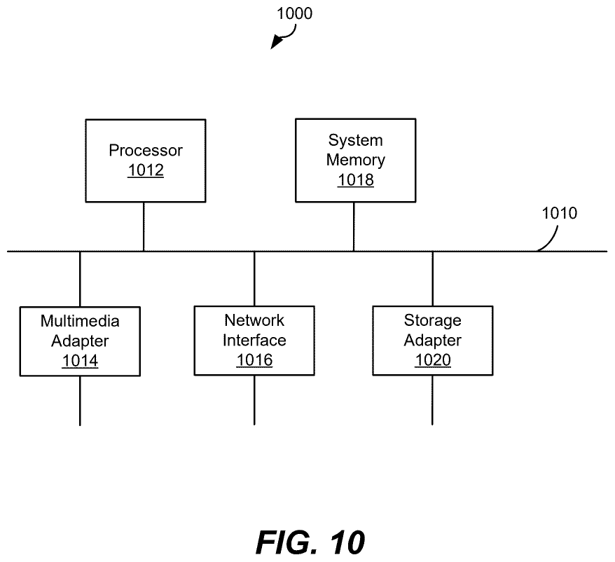

FIG. 10 illustrates an example of a computer system 1000 that may be implemented by devices illustrated in FIG. 1. The computer system 1000 may be part of or include the system environment 100 to perform the functions and features described herein. For example, various ones of the devices of system environment 100 may be implemented based on some or all of the computer system 1000. The computer system 1000 may include, among other things, an interconnect 1010, a processor 1012, a multimedia adapter 1014, a network interface 1016, a system memory 1018, and a storage adapter 1020.

The interconnect 1010 may interconnect various subsystems, elements, and/or components of the computer system 1000. As shown, the interconnect 1010 may be an abstraction that may represent any one or more separate physical buses, point-to-point connections, or both, connected by appropriate bridges, adapters, or controllers. In some examples, the interconnect 1010 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 1010 may allow data communication between the processor 1012 and system memory 1018, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 1012 may control operations of the computer system 1000. In some examples, the processor 1012 may do so by executing instructions such as software or firmware stored in system memory 1018 or other data via the storage adapter 1020. In some examples, the processor 1012 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 1014 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 1016 may provide the computer system 1000 with an ability to communicate with a variety of remote devices over a network. The network interface 1016 may include, for example, an Ethernet adapter, a Fibre Channel adapter, and/or other wired- or wireless-enabled adapter. The network interface 1016 may provide a direct or indirect connection from one network element to another, and facilitate communication to and between various network elements. The storage adapter 1020 may connect to a standard computer readable medium for storage and/or retrieval of information, such as a fixed disk drive (internal or external).

Other devices, components, elements, or subsystems (not illustrated) may be connected in a similar manner to the interconnect 1010 or via a network. The devices and subsystems can be interconnected in different ways from that shown in FIG. 10. Instructions to implement various examples and implementations described herein may be stored in computer-readable storage media such as one or more of system memory 1018 or other storage. Instructions to implement the present disclosure may also be received via one or more interfaces and stored in memory. The operating system provided on computer system 1000 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The conversion tables 141, contextual rules 143, and/or other system data may be stored in databases. These databases may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a processor programmed to:
access an input sequence having a plurality of characters in a source language to be transliterated into a target language;
execute a higher-order function that takes as input the input sequence, a window size parameter that defines a number of characters to be included in a window, and an identification of a reducing function;
generate, by the higher-order function, a plurality of sliding windows based on the input sequence and the window size parameter, wherein each sliding window comprises a number of characters from the input sequence that is based on the window size to capture context for one or more characters in the sliding window to be transliterated,
for each of at least some of the sliding windows from among the plurality of sliding windows:
execute, by the higher-order function, the reducing function to transliterate one or more characters in the sliding window based on the captured context from the sliding window;
transliterate, by the reducing function, one or more characters in the sliding window based on the captured context from the sliding window;
update, by the reducing function, an accumulator map comprising a vector of characters based on the transliteration and a number of characters to skip in a next iteration; and
generate a sequence of characters in the target language based on the vector of characters.

2. The system of claim 1, wherein the processor is further programmed to:
provide, as input to the reducing function, the accumulator map from a prior execution of the reducing function on a prior sliding window.

3. The system of claim 1, wherein for at least one sliding window from among the plurality of sliding windows, the processor is further programmed to:
determine, by the reducing function, that one or more characters in the sliding window has been processed;
set, by the reducing function, a parameter that indicates that the one or more characters has been processed; and
pass, by the reducing function, the parameter for input back to the reducing function in a next iteration for a next sliding window.

4. The system of claim 1, wherein the processor is further programmed to:
read the parameter upon execution for the next sliding window; and
skip processing of the one or more characters in the sliding window that has been processed.

5. The system of claim 1, wherein to transliterate the one or more characters in the sliding window, the processor is further programmed to:
execute a transposition of one or more characters in the input sequence to transpose the one or more characters to a position later in the input sequence based on one or more transposition rules for the source language.

6. The system of claim 1, wherein to transliterate the one or more characters in the sliding window, the processor is further programmed to:
execute a deletion of one or more characters in the input sequence based on one or more deletion rules for the source language.

7. The system of claim 1, wherein to transliterate the one or more characters in the sliding window, the processor is further programmed to:
execute an insertion of one or more characters in the input sequence based on one or more insertion rules for the source language.

8. The system of claim 1, wherein to transliterate the one or more characters in the sliding window, the processor is further programmed to:
execute a transcription of one or more characters in the input sequence based on one or more conversion tables for the source language.

9. The system of claim 1, wherein to transliterate the one or more characters in the sliding window, the processor is further programmed to:
in sequential order, execute:
(i) a transposition of one or more characters in the input sequence to transpose the one or more characters to a position later in the input sequence based on one or more transposition rules for the source language;
(ii) a deletion of one or more characters in the input sequence based on one or more deletion rules for the source language;
(iii) an insertion of one or more characters in the input sequence based on one or more insertion rules for the source language; and
(iv) a transcription of one or more characters in the input sequence based on one or more conversion tables for the source language.

10. The system of claim 1, wherein the processor is further programmed to:
pre-process the input sequence to remove one or more characters that are not to be transliterated.

11. The system of claim 1, wherein the source language is Thai and the target language is Latin.

12. A method, comprising:
accessing, by a processor, an input sequence having a plurality of characters in a source language to be transliterated into a target language;
executing, by the processor, a higher-order function that takes as input the input sequence, a window size parameter that defines a number of characters to be included in a window, and an identification of a reducing function;
generating, by the processor, by the higher-order function, a plurality of sliding windows based on the input sequence and the window size parameter, wherein each sliding window comprises a number of characters from the input sequence that is based on the window size to capture context for one or more characters in the sliding window to be transliterated,
for each of at least some of the sliding windows from among the plurality of sliding windows:
executing, by the processor, via the higher-order function, the reducing function to transliterate one or more characters in the sliding window based on the captured context from the sliding window;
transliterating, by the processor, via the reducing function, one or more characters in the sliding window based on the captured context from the sliding window;
updating, by the processor, via the reducing function, an accumulator map comprising a vector of characters based on the transliteration and a number of characters to skip in a next iteration; and
generating, by the processor, a sequence of characters in the target language based on the vector of characters.

13. The method of claim 12, the method further comprising:
providing, as input to the reducing function, the accumulator map from a prior execution of the reducing function on a prior sliding window.

14. The method of claim 12, wherein for at least one sliding window from among the plurality of sliding windows, the method further comprising:
determining, by the reducing function, that one or more characters in the sliding window has been processed;
setting, by the reducing function, a parameter that indicates that the one or more characters has been processed; and
passing, by the reducing function, the parameter for input back to the reducing function in a next iteration for a next sliding window.

15. The method of claim 12, the method further comprising:
reading the parameter upon execution for the next sliding window; and
skipping processing of the one or more characters in the sliding window that has been processed.

16. The method of claim 12, wherein transliterating the one or more characters in the sliding window comprises:
in sequential order, executing:
(i) a transposition of one or more characters in the input sequence to transpose the one or more characters to a position later in the input sequence based on one or more transposition rules for the source language;
(ii) a deletion of one or more characters in the input sequence based on one or more deletion rules for the source language;
(iii) an insertion of one or more characters in the input sequence based on one or more insertion rules for the source language; and
(iv) a transcription of one or more characters in the input sequence based on one or more conversion tables for the source language.

17. The method of claim 12, the method further comprising:
pre-processing the input sequence to remove one or more characters that are not to be transliterated.

18. A non-transitory computer readable medium storing instructions that, when executed by a processor, programs the processor to:
access an input sequence having a plurality of characters in a source language to be transliterated into a target language;
execute a higher-order function that takes as input the input sequence, a window size parameter that defines a number of characters to be included in a window, and an identification of a reducing function;
generate, by the higher-order function, a plurality of sliding windows based on the input sequence and the window size parameter, wherein each sliding window comprises a number of characters from the input sequence that is based on the window size to capture context for one or more characters in the sliding window to be transliterated,
for each of at least some of the sliding windows from among the plurality of sliding windows:
execute, by the higher-order function, the reducing function to transliterate one or more characters in the sliding window based on the captured context from the sliding window;
transliterate, by the reducing function, one or more characters in the sliding window based on the captured context from the sliding window;
update, by the reducing function, an accumulator map comprising a vector of characters based on the transliteration and a number of characters to skip in a next iteration; and
generate a sequence of characters in the target language based on the vector of characters.

19. The non-transitory computer readable medium of claim 18, wherein the instructions, when executed, further program the processor to:
determine, by the reducing function, that one or more characters in the sliding window has been processed;
set, by the reducing function, a parameter that indicates that the one or more characters has been processed;
pass, by the reducing function, the parameter for input back to the reducing function in a next iteration for a next sliding window;
read the parameter upon execution for the next sliding window; and
skip processing of the one or more characters in the sliding window that has been processed.

20. The non-transitory computer readable medium of claim 18, wherein the instructions, when executed, further program the processor to:
in sequential order, execute:
(i) a transposition of one or more characters in the input sequence to transpose the one or more characters to a position later in the input sequence based on one or more transposition rules for the source language;
(ii) a deletion of one or more characters in the input sequence based on one or more deletion rules for the source language;
(iii) an insertion of one or more characters in the input sequence based on one or more insertion rules for the source language; and
(iv) a transcription of one or more characters in the input sequence based on one or more conversion tables for the source language.
